(19) United States
(12) Patent Application Publication
(10) Pub. No.: US 2026/0292592 A1
(43) Pub. Date: Sep. 24, 2026

(54) COMMUNICATION APPARATUS, METHOD OF CONTROLLING COMMUNICATION APPARATUS, AND STORAGE MEDIUM

(71) Applicant: CANON KABUSHIKI KAISHA, Tokyo (JP)

(72) Inventor: YUKI TSUJIMARU, Kanagawa (JP)

(21) Appl. No.: 19/688,122

(22) Filed: May 26, 2026

Related U.S. Application Data
(63) Continuation of application No. PCT/JP2024/040903, filed on Nov. 19, 2024.

(30) Foreign Application Priority Data
Nov. 28, 2023 (JP) 2023-201136

(51) Int. Cl. H04W 28/06

(52) U.S. Cl. CPC H04W 28/06

(57) ABSTRACT

A communication apparatus includes a generation unit configured to generate a Medium Access Control (MAC) frame including a MAC header, a Counter Mode with Cipher Block Chaining Message Authentication Code Protocol (CCMP) header, and a data field compliant with an Institute of Electrical and Electronics Engineers (IEEE) 802.11 standard, and a transmission unit configured to transmit the MAC frame generated by the generation unit, wherein information indicating that data included in the data field of the generated MAC frame is data for which low latency communication is required is included in a Frame Control field or an HT Control field of the MAC header.

### CROSS-REFERENCE TO RELATED APPLICATIONS

This application is a Continuation of International Patent Application No. PCT/JP2024/040903, filed Nov. 19, 2024, which claims the benefit of Japanese Patent Application No. 2023-201136, filed Nov. 28, 2023, both of which are hereby incorporated by reference herein in their entirety.

### BACKGROUND

### Field of the Technology

The present disclosure relates to a communication apparatus that performs wireless communication, a method of controlling the communication apparatus, and a storage medium.

### Description of the Related Art

As a communication standard related to a wireless local area network (LAN), an Institute of Electrical and Electronics Engineers (IEEE) 802.11 series of standards is known. The IEEE 802.11 series of standards includes standards such as IEEE 802.11a, 802.11b, 802.11g, 802.11n, 802.11ac, 802.11ax, and 802.11be. In the IEEE 802.11be standard and a successor standard thereto, it has been studied to improve communication efficiency and throughput and to reduce latency by causing a plurality of access point apparatuses (hereinafter simply referred to as APs) to operate in cooperation with each other.

In addition, United States Patent Application Publication No. 2022/0070772 describes a Restricted Target Wake Time (R-TWT) technique in which a period that can be used for communication of data for which low latency is required is provided and transmission of the data for which low latency is required is performed during the period.

With the above-described R-TWT technique, it is possible to reduce latency in a case where regularly generated data is transmitted in a scheduled period.

On the other hand, the data for which low latency is required may be generated out of the above-described scheduled period. To transmit such data with low latency, it is necessary to implement prioritized transmission using a technique different from the R-TWT technique.

Further, in the IEEE 802.11bn standard, which is studied as a successor standard to the IEEE 802.11be standard, or an Ultra High Reliability (UHR) standard, a preemption technique in which data for which low latency is required is caused to interrupt normal data for which low latency is not required is discussed. As one preemption technique, it is considered that, when data for which low latency is required is transmitted, a dedicated packet number and a dedicated replay counter are used to process the data for which low latency is required before the normal data.

As described above, by providing the dedicated packet number and the dedicated replay counter for the data for which low latency is required separately from those for the normal data, it is possible to rapidly process the data. However, a method for identifying whether the packet number and the replay counter are for the normal data or for the data for which low latency is required is not present.

### SUMMARY

In consideration of the above-described issues, the present disclosure is directed to determining an effective method of indicating whether a packet number and a replay counter are for normal data or for low-latency data.

According to an aspect of the present disclosure, a communication apparatus includes a generation unit configured to generate a Medium Access Control (MAC) frame including a MAC header, a Counter Mode with Cipher Block Chaining Message Authentication Code Protocol (CCMP) header, and a data field compliant with an Institute of Electrical and Electronics Engineers (IEEE) 802.11 standard, and a transmission unit configured to transmit the MAC frame generated by the generation unit, wherein information indicating that data included in the data field of the generated MAC frame is data for which low latency communication is required is included in a Frame Control field or an HT Control field of the MAC header.

Features of the present disclosure will become apparent from the following description of embodiments with reference to the attached drawings.

### BRIEF DESCRIPTION OF THE DRAWINGS

FIG. 1 is a diagram illustrating an example of a network configuration according to an embodiment.

FIG. 2 is a diagram illustrating an example of a hardware configuration of a communication apparatus according to the present embodiment.

FIG. 3 is a diagram illustrating an example of a functional configuration of the communication apparatus according to the present embodiment.

FIG. 4 is a diagram illustrating an example of operation of the communication apparatus on a transmitting side according to the present embodiment.

FIG. 5 is a diagram illustrating an example of operation of the communication apparatus on a receiving side according to the present embodiment.

FIG. 6 is a diagram illustrating an example of a configuration of a Medium Access Control (MAC) frame and a MAC header according to the present embodiment.

FIG. 7 is a diagram illustrating a setting example of field values for defining that data in a wireless frame is data for which low latency is required, in the MAC header according to the present embodiment.

FIG. 8 is a diagram illustrating an example of a configuration of a Counter Mode with Cipher Block Chaining Message Authentication Code Protocol (CCMP) header according to the present embodiment.

FIG. 9 is a diagram illustrating an example of a field for notifying that data in a wireless frame is data for which low latency is required, by using an HT Control field according to a modification of the present embodiment.

FIG. 10 is a diagram illustrating an example of a UHR OM frame format that is used when notifying that data in the wireless frame is data for which low latency is required, by using the HT Control field according to the modification of the present embodiment.

FIG. 11 is a diagram illustrating an example of operation of a transmission buffer for preferentially transmitting a wireless frame for low latency communication in the operation of the communication apparatus on the transmitting side according to the present embodiment.

FIG. 12 is a diagram illustrating an example of operation of a reception buffer for preferentially processing a wireless frame for low latency communication in the operation of the communication apparatus on the receiving side according to the present embodiment.

### DESCRIPTION OF THE EMBODIMENTS

Embodiments of the present disclosure are described in detail below with reference to the accompanying drawings. Note that configurations described in the following embodiments are merely examples, and the present disclosure is not limited to the illustrated configurations.

### First Embodiment

### (Configuration of Wireless Communication System)

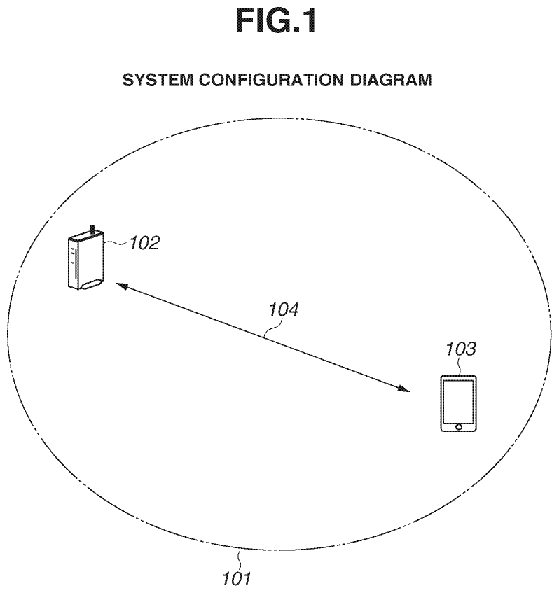

FIG. 1 illustrates a configuration of a wireless network according to the present disclosure. A wireless network 101 is formed by an access point apparatus (hereinafter also referred to simply as an access point (AP)) 102, and a station apparatus (hereinafter also referred to simply as a station (STA)) 103 participates in the wireless network 101.

The AP 102 and the STA 103 are configured to be capable of performing wireless communication compliant with an Institute of Electrical and Electronics Engineers (IEEE) 802.11bn standard that is a successor standard to the IEEE 802.11be standard targeting a maximum transmission speed of 46.08 Gbps.

The main features of the IEEE 802.11bn standard are high-reliability communication, low latency communication, and improved throughput in times of congestion. A wireless frame communicated using the successor standard is also referred to as an Ultra High Reliability (UHR) physical layer (PHY) protocol data unit (PPDU).

The names “IEEE 802.11bn” and “UHR standard” are provided for convenience based on goals to be achieved by the successor standard and prominent features of the standard, and may be changed to different names when development of the standard is completed. On the other hand, note that the present specification and the appended claims are essentially applicable to all successor standards to the IEEE 802.11be standard.

Although the wireless network illustrated in FIG. 1 is configured with one AP and one STA, the number of APs and the number of STAs are not limited thereto. For example, the number of STAs may be larger by one than the number of APs. At this time, a frequency band and a bandwidth of a link to be established are not limited. Further, although the AP 102 and the STA 103 are described as being compliant with communication of a UHR PPDU compliant with the IEEE 802.11bn standard, the present disclosure is not limited thereto. In addition, the AP 102 and the STA 103 may be compliant with an IEEE 802.11 standard prior to the IEEE 802.11bn standard. Specifically, the AP 102 and the STA 103 may be configured to be compliant with communication of a PPDU according to IEEE 802.11a, 802.11b, 802.11g, 802.11n, 802.11ac, 802.11ax, and 802.11be standards and the like.

Further, the AP 102 and the STA 103 may be compliant with, in addition to the IEEE 802.11 standard series, other communication standards such as Bluetooth®, Near Field Communication (NFC), Ultra Wide Band (UWB), ZigBee, and Multi Band OFDM Alliance (MBOA). The UWB includes wireless universal serial bus (USB), wireless 1394, WiNET, and the like. Further, the AP 102 and the STA 103 may be compliant with a communication standard for wired communication such as a wired local area network (LAN).

Specific examples of the AP 102 include a wireless LAN router and a personal computer (PC); however, the AP 102 is not limited thereto. The AP 102 may be an information processing apparatus that can perform wireless communication compliant with the IEEE 802.11bn standard, such as a wireless chip. Specific examples of the STA 103 include a camera, a tablet, a smartphone, a PC, a mobile phone, a video camera, and a headset; however, the STA 103 is not limited thereto. The STA 103 may be an information processing apparatus that can perform wireless communication compliant with the IEEE 802.11bn standard, such as a wireless chip.

The AP 102 and the STA 103 can perform communication at frequencies in a 2.4 GHz band, a 5 GHz band, and a 6 GHz band. The frequency bands used by each of the communication apparatuses are not limited thereto, and a different frequency band, for example, a 60 GHz band may also be used. In addition, the AP 102 and the STA 103 can perform communication in a bandwidth of 20 MHz, 40 MHz, 80 MHz, 160 MHz, 320 MHz, 640 MHz, and the like.

### (Configurations of AP and STA)

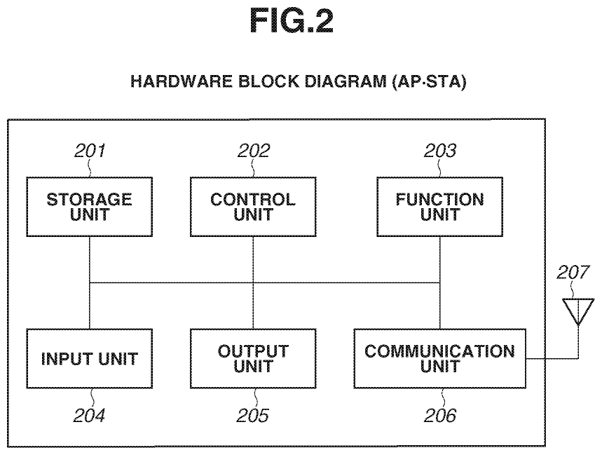

FIG. 2 illustrates a hardware configuration example of the communication apparatus (AP and STA) according to the present embodiment. As an example, the communication apparatus includes a storage unit 201, a control unit 202, a function unit 203, an input unit 204, an output unit 205, a communication unit 206, and an antenna 207. The antenna may be a single antenna or a plurality of antennas.

The storage unit 201 includes one or more memories such as a read only memory (ROM) and a random access memory (RAM), and stores computer programs for performing various kinds of operation described below, and various kinds of information such as communication parameters for wireless communication. As the storage unit 201, in addition to the memories such as the ROM and the RAM, a storage medium such as a flexible disk, a hard disk, a solid-state drive (SSD), an optical disc, a magneto-optical disc, a compact disc read only memory (CD-ROM), a compact disc-recordable (CD-R), a magnetic tape, a nonvolatile memory card, and a digital versatile disc (DVD) may be used. In addition, the storage unit 201 may include a plurality of memories and the like.

The control unit 202 includes one or more processors such as a central processing unit (CPU) and a micro processing unit (MPU), and controls the entire AP 102 by executing the computer programs stored in the storage unit 201. The control unit 202 may control the entire AP 102 through cooperation of the computer programs and an operating system (OS) stored in the storage unit 201. Further, the control unit 202 generates data and signals (wireless frames) to be transmitted in communication with another communication apparatus. The control unit 202 may include a plurality of processors such as multicore processors, and the plurality of processors may control the entire communication apparatus.

In addition, the control unit 202 controls the function unit 203 to perform predetermined processing such as wireless communication, imaging, printing, and projection. The function unit 203 is hardware for the communication apparatus to perform the predetermined processing.

The input unit 204 receives various kinds of operation from a user. The output unit 205 performs various kinds of output to the user via a monitor screen and a speaker. The output by the output unit 205 may be a display on the monitor screen, audio output by the speaker, vibration output, and the like. Both the input unit 204 and the output unit 205 may be implemented as one module such as a touch panel. Each of the input unit 204 and the output unit 205 may each be integrated with or separate from the communication apparatus.

The communication unit 206 controls wireless communication compliant with the IEEE 802.11bn standard. Further, in addition to the IEEE 802.11bn standard, the communication unit 206 may also control wireless communication compliant with the other IEEE 802.11 series standards and wired communication such as a wired LAN. The communication unit 206 controls the antenna 207 to transmit and receive signals for the wireless communication that are generated by the control unit 202.

In a case where the communication apparatus is compliant with an NFC standard, a Bluetooth® standard, and the like in addition to the IEEE 802.11bn standard, the communication unit 206 may control wireless communication compliant with these communication standards. Further, in a case where the communication apparatus can perform wireless communication compliant with a plurality of communication standards, the communication apparatus may individually include a communication unit and an antenna that are compliant with each of the communication standards. The communication apparatus communicates data such as image data, document data, and video image data with another communication apparatus via the communication unit 206. The antenna 207 may be configured separately from the communication unit 206, or the antenna 207 and the communication unit 206 may be combined as one module.

The antenna 207 is an antenna capable of performing communication in the 2.4 GHz band, the 5 GHz band, and the 6 GHz band. The communication apparatus may include one antenna or a plurality of antennas. Further, the communication apparatus may include different antennas for respective frequency bands. In a case where the AP 102 includes a plurality of antennas 207, the AP 102 may include communication units 206 corresponding to the respective antennas 207.

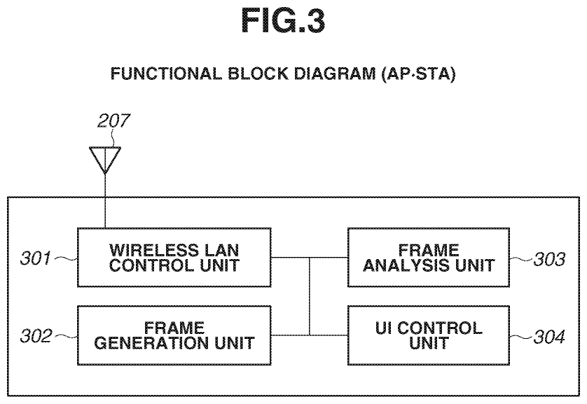

Subsequently, a functional configuration of the communication apparatus (AP 102 and STA 103) is described with reference to FIG. 3. FIG. 3 is a block diagram illustrating the functional configuration of the communication apparatus according to the present embodiment.

The communication apparatus includes a wireless LAN control unit 301, a frame generation unit 302, a frame analysis unit 303, and a user interface (UI) control unit 304.

The wireless LAN control unit 301 controls the communication unit 206 and the antenna 207 for transmitting and receiving wireless signals to and from another wireless LAN apparatus. Specifically, the wireless LAN control unit 301 performs communication control of wireless frames in accordance with the IEEE 802.11 standard series in cooperation with the frame generation unit 302 and the frame analysis unit 303.

The frame generation unit 302 generates the wireless frame to be transmitted by the wireless LAN control unit 301. The wireless frame includes a preamble field and a data field. In the data field, Medium Access Control (MAC) frames such as a management frame, a control frame, and a data frame are stored. Further, the wireless frame may be changed by user settings via the UI control unit 304.

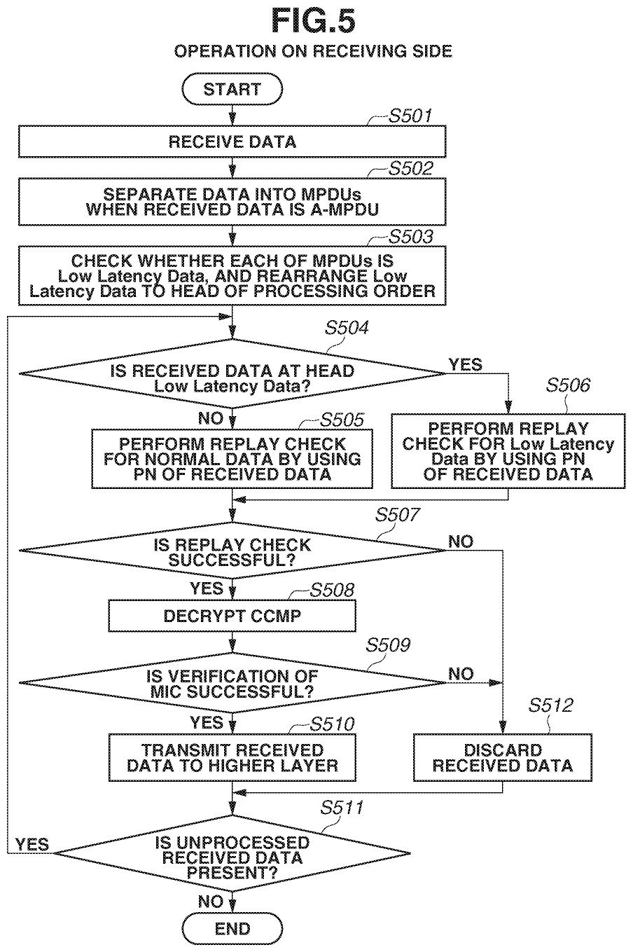

Information on the generated wireless frame is transmitted to the wireless LAN control unit 301, and is transmitted to the outside by the communication unit 206 and the antenna 207. Information on a wireless frame received through cooperation of the communication unit 206, the antenna 207, and the wireless LAN control unit 301 is transferred to and analyzed by the frame analysis unit 303. Although details are described with reference to FIG. 5 and subsequent figures, the frame analysis unit 303 analyzes a MAC header and a Counter Mode with Cipher Block Chaining Message Authentication Code Protocol (CCMP) header of the received wireless frame, and determines whether received data is data for which low latency is required. Further, the frame analysis unit 303 analyzes a packet number in the CCMP header and performs a replay check using a replay counter. A replay counter for data for which low latency is required and a replay counter for normal data for which low latency is not required are prepared. When the data for which low latency is required is received, a replay check is performed by comparing a value of the replay counter for the data for which low latency is required with a packet number of the received data.

The UI control unit 304 includes hardware relating to a user interface such as a touch panel or a button for receiving operation for the STA 103 from the AP 102 by a user (not illustrated), and programs for controlling the hardware. Further, the UI control unit 304 also has a function for presenting information to the user, for example, through display of an image or the like and audio output.

(Method of Notifying Data for which Low Latency is Required, and Communication Control Method)

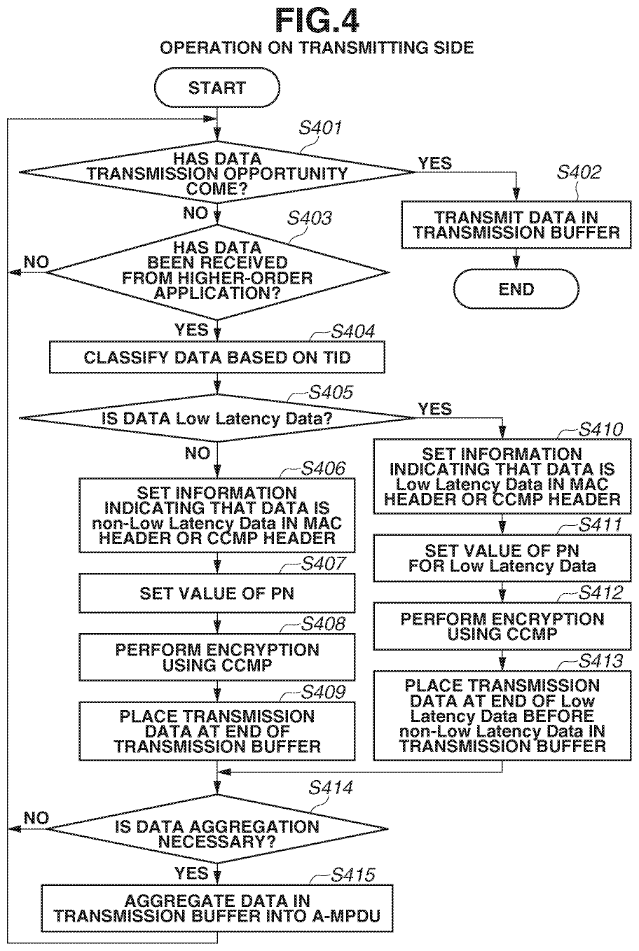

First, a method of indicating, when the AP 102 transmits data to the STA 103, whether the data is data for which low latency is required (hereinafter also referred to as Low Latency data) is described with reference to FIG. 4. In the present embodiment, for the sake of explanation, it is assumed that the AP 102 transmits data to the STA 103; however, data transmission is not limited thereto. For example, a similar method may be applied in a case where the STA 103 transmits data to the AP 102.

In step S401, the AP 102 determines whether a data transmission opportunity has come by an access method using Enhanced Distributed Channel Access (EDCA) or the like. In a case where the data transmission opportunity has come (YES in step S401), in step S402, the AP 102 can transmit data accumulated in a transmission buffer at that time.

In a case where the data transmission opportunity has not come (NO in step S401), in step S403, the AP 102 checks whether data to be transmitted has been received from a higher-order application. In a case where the transmission data has been received from the higher-order application (YES in step S403), first, in step S404, the AP 102 classifies the data based on Traffic Identifier (TID).

Subsequently, in step S405, the AP 102 determines whether the transmission data is Low Latency data. At this time, it may be determined whether the transmission data is Low Latency data, for example, based on a type of application, or an identifier indicating that the transmission data is Low Latency data may be notified by the application; however, the determination is not limited thereto.

In a case where the transmission data is data other than Low Latency data (hereinafter also referred to as non-Low Latency data) (NO in step S405), in step S406, information indicating that the transmission data is non-Low Latency data is set in the MAC header.

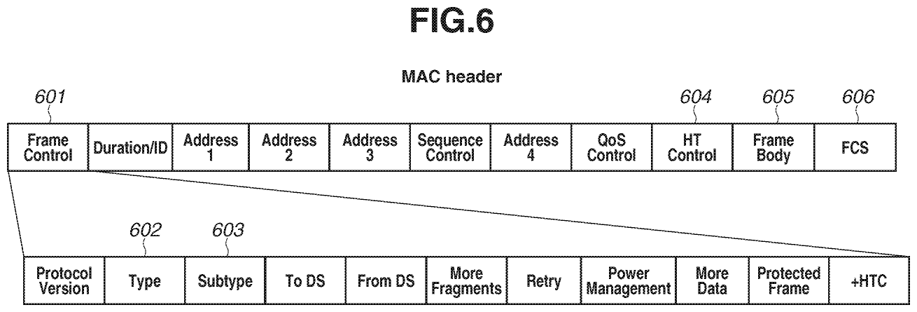

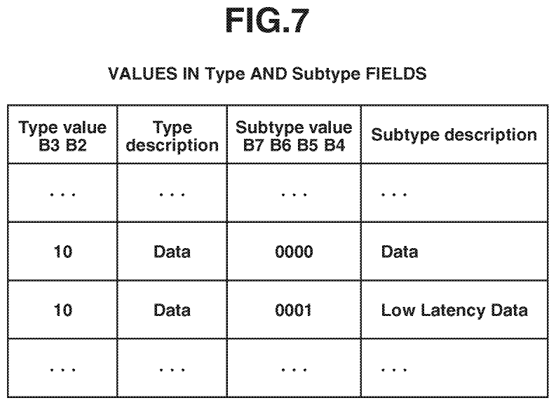

Specifically, values other than values indicating that the transmission data is Low Latency data are set in a Type subfield 602 and a Subtype subfield 603 included in a Frame Control field 601 in the MAC header illustrated in FIG. 6. For example, as illustrated in FIG. 7, by setting “10” in binary notation in the Type subfield and “0000” in binary notation in the Subtype subfield, it is possible to indicate that the transmission data is non-Low Latency data.

In the IEEE 802.11 standards, from the Frame Control field 601 to an HT Control field 604 illustrated in FIG. 6 are defined as the MAC header. Further, from the Frame Control field 601 to an FCS field 606 illustrated in FIG. 6 are defined as a MAC frame. In the present specification, a portion other than the MAC header and the FCS field 606 of the MAC frame is referred to as a payload.

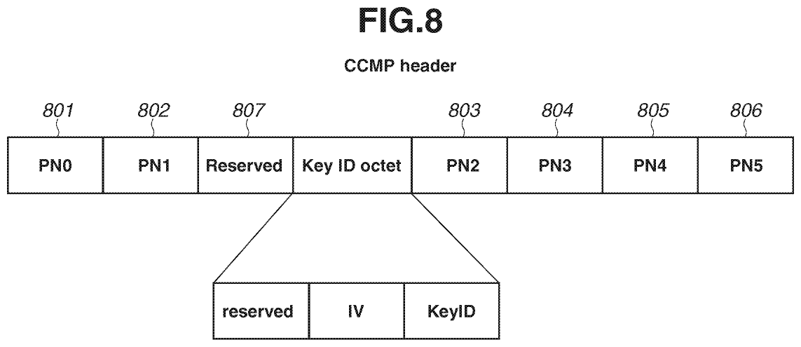

Subsequently, in step S407, a value of a packet number (hereinafter simply referred to as PN) is set. Specifically, the value of the packet number (PN) is set using a PN0 field 801, a PN1 field 802, a PN2 field 803, a PN3 field 804, a PN4 field 805, and a PN5 field 806 included in a CCMP header illustrated in FIG. 8. As the value of the PN, a value obtained by incrementing by one the PN of immediately preceding non-Low Latency data is set. The CCMP header is located after the MAC header.

Subsequently, in step S408, encryption using CCMP is performed. In step S409, a generated MAC Service Data Unit (MSDU) is placed as transmission data at the end of the transmission buffer.

Meanwhile, in a case where the data in the payload is Low Latency data in step S405 (YES in step S405), in step S410, information indicating that the transmission data is Low Latency data is set in the MAC header. Specifically, values indicating that the transmission data is Low Latency data are set in the Type subfield 602 and the Subtype subfield 603 included in the Frame Control field 601 in the MAC header illustrated in FIG. 6. For example, as illustrated in FIG. 7, by setting “10” in binary notation in the Type subfield and “0001” in binary notation in the Subtype subfield, it is possible to newly indicate that the transmission data is Low Latency data, as compared with an existing method.

Then, in step S411, a value of PN dedicated to the Low Latency data is set using the PN0 field 801, the PN1 field 802, the PN2 field 803, the PN3 field 804, the PN4 field 805, and the PN5 field 806 included in the CCMP header illustrated in FIG. 8. At this time, the PN dedicated to the Low Latency data is set independently of the PN for the non-Low Latency data. In other words, a value obtained by incrementing by one the PN of immediately preceding Low Latency data is set. A value of a first PN may overlap with the PN for the non-Low Latency data, or a value not overlapping with the PN for the non-Low Latency data may be set. In a case where the value not overlapping with the PN for the non-Low Latency data is set, for example, a value in which the most significant bit of the PN is 1 may be assigned to the PN for the Low Latency data.

After the PN is set, in step S412, encryption using CCMP is performed to generate an MSDU. Then, in step S413, the transmission data is placed at the end of the Low Latency data and before the non-Low Latency data in the transmission buffer.

After the data are accumulated in the transmission buffer, in steps S414 and S415, MAC Protocol Data Units (MPDUs) in the buffer may be aggregated to form an Aggregate MPDU (A-MPDU), as necessary.

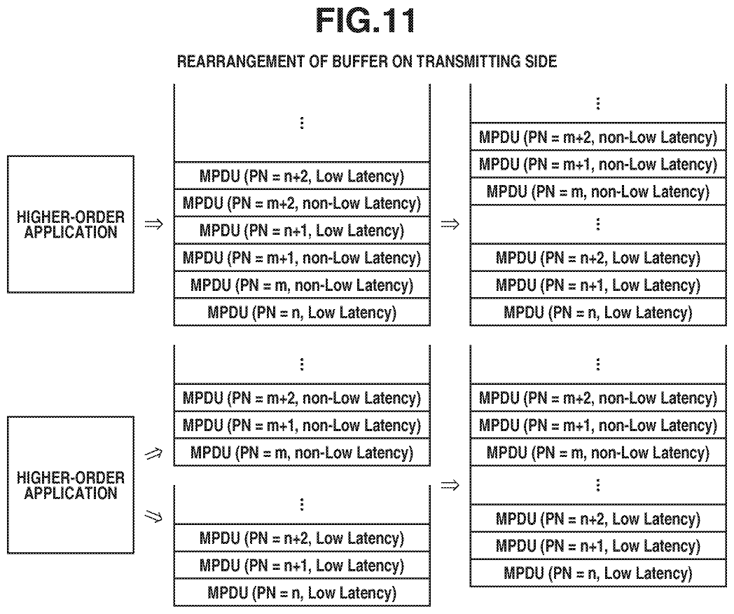

As for the processing in steps S413 to S415, for example, the processing in step S413 may be performed each time Low Latency data arrives, or data may be accumulated in the buffer once in the order of arrival, and then the data may be rearranged immediately before the processing in step S415 as illustrated in FIG. 11. Further, buffers may be separated in advance for the non-Low Latency data and the Low Latency data, and the respective buffers may be combined immediately before the processing in step S415 is performed. Further, the processing may be performed such that the Low Latency data is placed before the non-Low Latency data.

Next, operation for determining, when the STA 103 receives data from the AP 102, whether the data is Low Latency data and for transmitting received data to a higher-order application is described with reference to FIG. 5. In the present embodiment, for the sake of explanation, it is assumed that the STA 103 receives data from the AP 102; however, data reception is not limited thereto. For example, similar operation may be applied in a case where the AP 102 receives data from the STA 103.

In step S501, the STA 103 receives data. In step S502, in a case where the received data is an A-MPDU, the STA 103 separates the received A-MPDU into MPDUs.

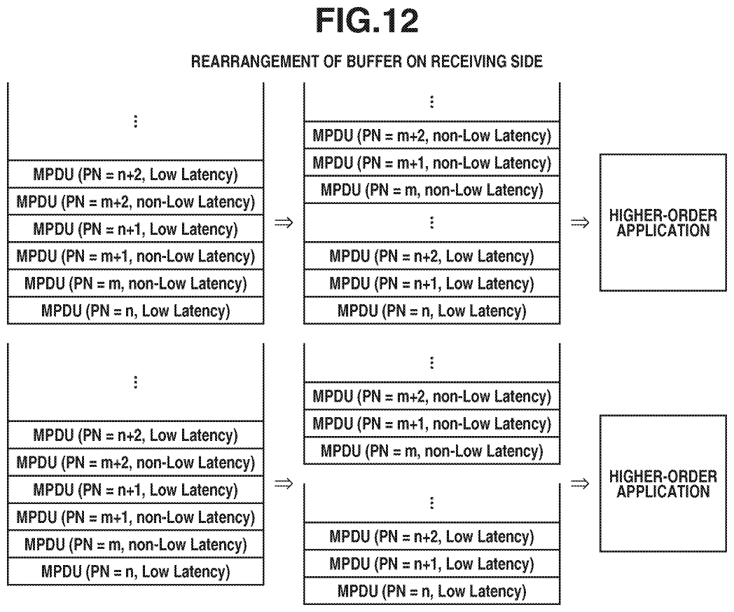

In step S503, a header of each of the MPDUs is checked once, and whether each of the MPDUs is Low Latency data is checked. If an MPDU is an MPDU of Low Latency data, the MPDU is rearranged to the head of a processing order so as to be processed with priority. For example, as illustrated in FIG. 12, after separation of the A-MPDU, the data may be rearranged such that, from a state where Low Latency data and non-Low Latency data are mixed, a state where the Low Latency data is placed before the non-Low Latency data is achieved. Further, a buffer for the non-Low Latency data and a buffer for Low Latency data may be prepared, and the data may be accumulated in the buffers while being rearranged. By the processing, it is possible to rapidly notify a higher layer of the Low Latency data. When the A-MPDU is configured on the transmitting side such that the Low Latency data is always placed before the non-Low Latency data, the processing in step S503 may be omitted.

After the MPDUs are rearranged, processing is performed on the MPDU at the head.

In step S504, the STA 103 checks whether data in the payload is Low Latency data. The STA 103 determines whether the data in the payload is Low Latency data by checking the values in the Type subfield 602 and the Subtype subfield 603 included in the Frame Control field 601 in the MAC header of the received data. Specific values are similar to the values described above. Therefore, description of the values is omitted.

In a case where it is determined that the received data is non-Low Latency data (NO in step S504), in step S505, replay check for non-Low Latency data is performed. In the replay check, for example, the maximum value of the PN of non-Low Latency data received so far is stored, and it is checked whether the PN of the non-Low Latency data received this time exceeds the stored maximum value. In a case where the PN exceeds the maximum value, the non-Low Latency data can be handled as data successful in the replay check.

Meanwhile, in a case where it is determined that the received data is Low Latency data in step S504 (YES in step S504), a replay check for Low Latency data is performed in step S506. The replay check for Low Latency data can be achieved by preparing a replay counter independent of a replay counter for non-Low Latency data and comparing a value of the replay counter with the PN of the Low Latency data. It is determined whether the PN of the received data is the PN of the Low Latency data based on whether the values in the Type subfield 602 and the Subtype subfield 603 included in the MAC header checked in step S504 indicate the Low Latency data. In a case where the values in these fields indicate the Low Latency data, it is determined that the PN indicated by the PN field of the CCMP header is the PN of the Low Latency data.

In a case where the replay check is successful (YES in step S507), in step S508, decryption of CCMP is performed. Subsequently, in step S509, Message Integrity Code (MIC) is verified. In a case where verification of MIC is successful (YES in step S509), the received data is transmitted to the higher layer in step S510.

Meanwhile, in a case where the replay check fails (NO in step S507) or in a case where verification of MIC fails (NO in step S509), the received data is discarded in step S512.

Thereafter, operation is repeated until processing is performed on all the received data.

FIG. 6 illustrates an example of a format of the MAC frame used in the present embodiment. The MAC header starts from the Frame Control field 601 and is followed by a Duration/ID field, an Address1 field, and the like. The Duration/ID field and subsequent fields are compliant with the existing IEEE 802.11 standard. Therefore, description of these fields is omitted. The Frame Control field 601 includes some subfields, namely, a Protocol Version subfield, the Type subfield 602, the Subtype subfield 603, a ToDS subfield, and the like in this order from the head. The ToDS subfield and subsequent subfields are compliant with the existing IEEE 802.11 standard. Therefore, description of these subfields is omitted.

Setting regarding whether the transmission data is Low Latency data is performed by storing predetermined values in the Type subfield and the Subtype subfield of the MAC header. For example, as illustrated in FIG. 7, by storing “10” indicating Data in the Type subfield 602 and “0001” indicating Low Latency Data in the Subtype subfield 603, it is possible to newly define a frame for transmitting Low Latency Data.

In the present embodiment, it is possible to indicate that the transmission data is Low Latency data by setting “10” in the Type subfield and “0001” in the Subtype subfield; however, the values are not limited thereto.

For example, “10” is set in the Type subfield, and “0010”, “0011”, “0101”, “0110”, “0111”, “1101”, or the like may be set in the Subtype subfield.

### First Modification

In the above-described embodiment, as the method of notifying that the transmission data is Low Latency data, the method of including the information indicating that the transmission data is Low Latency data in the MAC header is described. However, the method is not limited thereto, and the information indicating that the transmission data is Low Latency data may be included in the CCMP header.

As an example, a Reserved field 807, which is present in the CCMP header illustrated in FIG. 8, may be used to indicate that the transmission data is Low Latency data. In this case, for example, one bit of the Reserved field 807 is allocated to a bit for identifying Low Latency data. At this time, the bit value of zero may indicate that the transmission data is non-Low Latency data, and the bit value of one may indicate that the transmission data is Low Latency data.

Alternatively, the bit value of one may indicate that the transmission data is non-Low Latency data, and the bit value of zero may indicate that the transmission data is Low Latency data.

Further, at this time, a new field of one bit for identifying Low Latency data may be disposed in the CCMP header, and the new field may be disposed adjacent to the Reserved field 807.

Alternatively, instead of the determination whether the transmission data is Low Latency data or non-Low Latency data, priority in a plurality of levels may be set based on a degree of required Low Latency for each data. For example, one byte of the Reserved field 807 is defined as a field that notifies Low Latency priority. A value of zero may indicate non-Low Latency data, and a larger value may indicate data for which lower latency is required. In such a case, when the transmission data is stored in the transmission buffer, data having high priority may be stored on the head side of the buffer. Further, the replay counter on the receiving side may be managed independently by the number of priorities.

At this time, a new field in which a field for notifying the Low Latency priority is stored may be disposed in the CCMP header. All or a part of bits of the Reserved field 807 may be allocated to the new field.

### Second Modification

In the above-described embodiment, the Type subfield 602 and the Subtype subfield 603 included in the Frame Control field 601 in the MAC header are used to define the frame type indicating that the transmission data is Low Latency data. However, this is not limiting, and it is possible to indicate that the transmission data is Low Latency data in the MAC header.

For example, the HT Control field 604 illustrated in FIG. 6 may be used to indicate whether the transmission data is Low Latency data. Specific description is provided below.

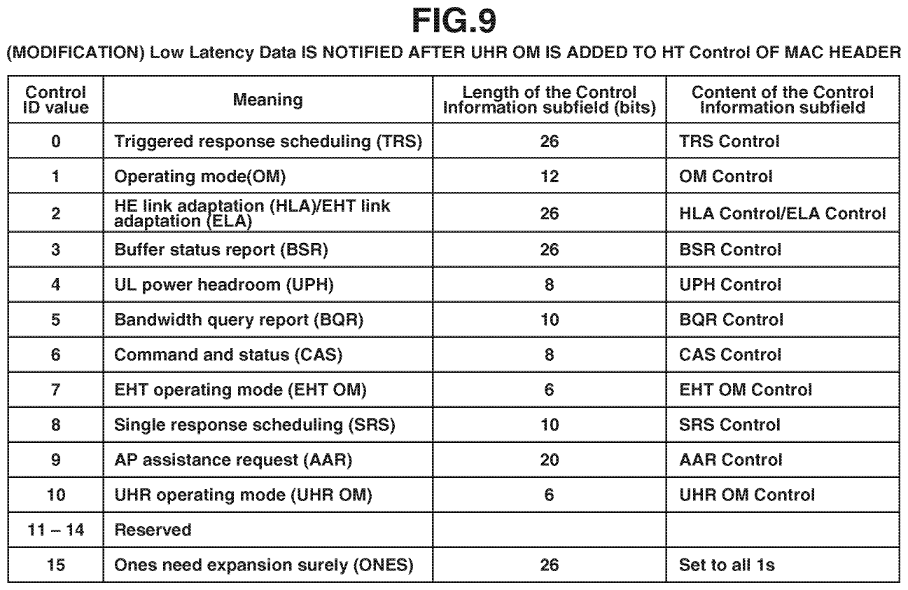

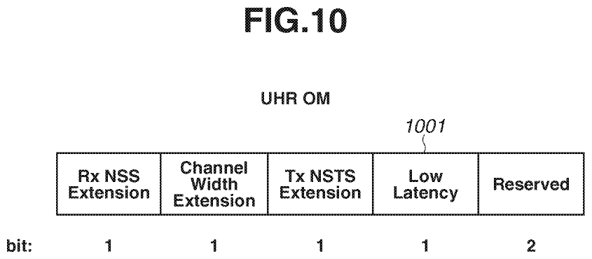

To indicate that data in the wireless frame is Low Latency data for the IEEE 802.11bn standard, HE Variant in the HT Control field 604 is used. A control Information subfield included in HE Variant is configured as illustrated in FIG. 9, and Control ID 10: UHR operating mode is added thereto. FIG. 10 illustrates an example of the Control Information subfield of the UHR operating mode. In the UHR operating mode, a Rx NSS Extension field, a Channel Width Extension field, and a Tx NSTS Extension field are fields that may be used to indicate PPDU characteristics in the UHR standard, and indicate information on a bandwidth and the like. A Low Latency field 1001 is a field indicating whether the transmission data is Low Latency data. For example, the value of zero in the field indicates that the transmission data is non-Low Latency data, and a value of one indicates that the transmission data is Low Latency data.

Operation on the transmission side in a case where UHR operating mode is used to notify whether the transmission data is Low Latency data is similar to the operation illustrated in FIG. 4. However, in step S410, a field in which the information indicating that the transmission data is Low Latency data is the Low Latency field of UHR operating mode data.

Further, operation on the receiving side is similar to the operation illustrated in FIG. 5. However, in step S504, a field checked to determine whether the transmission data is Low Latency data is the Low Latency field of the UHR operating mode data. An index for determining whether the PN is for Low Latency data or for non-Low Latency data is also the Low Latency field of UHR operating mode data.

### OTHER EMBODIMENTS

A storage medium in which program codes of software for implementing the above-described functions are stored may be supplied to a system or an apparatus, and a computer (CPU or MPU) of the system or the apparatus may read out and execute the program codes stored in the storage medium. In this case, the program codes read out from the storage medium implement the functions of the above-described embodiments, and the storage medium storing the program codes constitutes the above-described apparatus.

Examples of the storage medium for supplying the program codes include, for example, a flexible disk, a hard disk, an optical disc, a magneto-optical disc, a CD-ROM, a CD-R, a magnetic tape, a nonvolatile memory card, a ROM, and a DVD.

Further, the above-described functions may be implemented not only by the computer executing the read out program codes, but also by an OS running on the computer performing a part or all of actual processing based on instructions of the program codes.

Further, the above-described functions may be implemented by writing the program codes that have been read out from the storage medium in a memory of a function expansion board inserted into the computer or a memory of a function expansion unit connected to the computer, and the CPU provided on the function expansion board or the function expansion unit performs a part or all of actual processing based on the instructions of the program codes.

The present disclosure can be realized by supplying programs that implement one or more functions of the above-described embodiments to a system or an apparatus via a network or a storage medium, and causing one or more processors in a computer of the system or the apparatus to read out and execute the programs. Further, the present disclosure can also be realized by a circuit (e.g., application specific integrated circuit (ASIC)) implementing one or more functions.

The present disclosure is not limited to the above-described embodiments, and various changes and modifications can be made without departing from the spirit and the scope of the present disclosure. Accordingly, the following claims are appended hereto to make public the scope of the present disclosure.

According to the present disclosure, it is possible to notify whether a packet number and a replay counter in a wireless frame to be transmitted and received are for data for which low latency is required.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication apparatus comprising:
a generation unit configured to generate a Medium Access Control (MAC) frame including a MAC header, a Counter Mode with Cipher Block Chaining Message Authentication Code Protocol (CCMP) header, and a data field compliant with an Institute of Electrical and Electronics Engineers (IEEE) 802.11 standard; and
a transmission unit configured to transmit the MAC frame generated by the generation unit,
wherein information indicating that data included in the data field of the generated MAC frame is data for which low latency communication is required is included in a Frame Control field or an HT Control field of the MAC header.

2. The communication apparatus according to claim 1, wherein the information indicating that the data is data for which low latency communication is required is included in a Type subfield and a Subtype subfield of the Frame Control field.

3. The communication apparatus according to claim 1, wherein, in a case where a predetermined value is set to a Control ID of the HT Control field, the information indicating that the data is data for which low latency communication is required is included in a Control Information subfield.

4. The communication apparatus according to claim 1, wherein the CCMP header is located after the MAC header.

5. A communication apparatus comprising:
a generation unit configured to generate a MAC frame including a MAC header, a CCMP header, and a data field compliant with an IEEE 802.11 standard; and
a transmission unit configured to transmit the MAC frame generated by the generation unit,
wherein information indicating that data included in the data field of the generated MAC frame is data for which low latency communication is required is included in a field located among a plurality of fields indicating a packet number, of the CCMP header.

6. The communication apparatus according to claim 1, wherein the data for which low latency communication is required is Low Latency data compliant with the IEEE 802.11 standard.

7. The communication apparatus according to claim 1, wherein, in a case where the information indicating that the data included in the data field is data for which low latency communication is required is included in the MAC header or the CCMP header of the MAC frame, information on a packet number used for processing of the data for which low latency communication is required is included in the CCMP header.

8. The communication apparatus according to claim 1, wherein a packet number used for processing of the data for which low latency communication is required is set independently of a packet number used for processing of data for which low latency communication is not required.

9. A communication apparatus comprising a reception unit configured to receive a MAC frame including a MAC header, a CCMP header, and a data field compliant with an IEEE 802.11 standard,
wherein information indicating that data included in the data field of the received MAC frame is data for which low latency communication is required is included in a Frame Control field or an HT Control field of the MAC header.

10. The communication apparatus according to claim 9, wherein a Type subfield and a Subtype subfield of the Frame Control field are used to indicate that the data is data for which low latency communication is required.

11. The communication apparatus according to claim 9, wherein, in a case where a predetermined value is set to a Control ID of the HT Control field, the information indicating that the data is data for which low latency communication is required is included in a Control Information subfield.

12. A communication apparatus comprising a reception unit configured to receive a MAC frame including a MAC header, a CCMP header, and a data field compliant with an IEEE 802.11 standard,
wherein information indicating that data included in the data field of the received MAC frame is data for which low latency communication is required is included in a field located among a plurality of fields indicating a packet number, of the CCMP header.

13. The communication apparatus according to claim 9, further comprising a determination unit configured to determine whether the received data is data for which low latency communication is required, based on information in the MAC header or the CCMP header of the received MAC frame.

14. The communication apparatus according to claim 13, wherein, in a case where the determination unit determines that the data received by the reception unit is data for which low latency communication is required, the received data is processed before data for which low latency communication is not required.

15. The communication apparatus according to claim 9, wherein the data for which low latency communication is required is Low Latency data compliant with the IEEE 802.11 standard.

16. The communication apparatus according to claim 9, wherein, in a case where the information indicating that the data included in the data field is data for which low latency communication is required is included in the MAC header or the CCMP header of the MAC frame, information on a packet number used for processing of the data for which low latency communication is required is included in the CCMP header.

17. A method of controlling a communication apparatus, the method comprising:
generating a MAC frame including a MAC header, a CCMP header, and a data field compliant with an IEEE 802.11 standard; and
transmitting the generated MAC frame,
wherein information indicating that data included in the data field of the generated MAC frame is data for which low latency communication is required is included in a Frame Control field or an HT Control field of the MAC header.

18. A method of controlling a communication apparatus, the method comprising receiving a MAC frame including a MAC header, a CCMP header, and a data field compliant with an IEEE 802.11 standard,
wherein information indicating that data included in the data field of the received MAC frame is data for which low latency communication is required is included in a Frame Control field or an HT Control field of the MAC header.

19. A non-transitory computer-readable storage medium storing a program for causing a computer to operate as a communication apparatus according to claim 1.
